(19) United States
(12) Patent Application Publication
(10) Pub. No.: US 2022/0020055 A1
(43) Pub. Date: Jan. 20, 2022

(54) SYSTEMS AND METHODS FOR MANAGING AND CONTROLLING ELECTRONIC MESSAGING CAMPAIGNS

(71) Applicant: SHOPIFY INC., Ottawa (CA)

(72) Inventors: Kyle Bruce TATE, Ottawa (CA); Brooke FITZGERALD, Montreal (CA); Pascal POTVIN, Laval (CA)

(21) Appl. No.: 16/930,916

(22) Filed: Jul. 16, 2020

(51) Int. Cl. G06Q 30/02

(52) U.S. Cl. CPC G06Q 30/0248; G06Q 30/0277

(57) ABSTRACT

Methods and systems for managing messaging campaigns are disclosed. A set of parameters are received for a proposed messaging campaign. Based on a trust indicator associated with the proposed messaging campaign, it is determined that the proposed messaging campaign should be blocked. At least one tracked message is transmitted to at least one selected recipient, where the tracked message is at least a subset of messages for the proposed messaging campaign. If a rejection metric associated with the tracked message passes a rejection threshold, messages are transmitted to the remaining recipients.

### FIELD

The present disclosure relates to multicomputer messaging, and, more particularly, to methods and systems for managing and controlling messaging campaigns, including blocking messaging campaigns.

### BACKGROUND

Marketers and merchants often use messaging campaigns to communicate certain message contents to an intended group of audience. For stores having an online presence (e.g., an e-commerce store), such messaging campaigns often include messages sent via electronic channels, such as via email or social media.

Conventionally, when a user uses a campaign generator in bad faith (such a user may be referred to as a “bad actor”) to send spam messages, an email service may detect the messages as spam and block all future messages from that bad actor. Detection of a bad actor may be performed using a detection algorithm.

### SUMMARY

In detection of bad actors using conventional means, there may be false positive detections, in which a legitimate user is erroneously detected as a bad actor and blocked from sending messages. A user who is erroneously blocked may be required to contact a support center or administrator in order to become unblocked. This may be inconvenient to the user as well as workers at the support center.

The present disclosure describes various examples which may enable a messaging service, or an online platform that provides a messaging service, to obtain feedback data that may help to refine or correct trustworthiness assessments. In some examples, the disclosed methods and systems enable a small amount of tracked messages to be transmitted from an otherwise blocked messaging campaign. Response to the tracked messages may be used to determine a rejection metric, and the rejection metric may be used as feedback data to: unblock the messaging campaign; confirm that the messaging campaign should be blocked; and/or refine the trustworthiness assessment. Conveniently, in this way, messaging campaigns may be more effectively managed as compared to when conventional means are employed for detecting bad messaging actors.

The examples described herein may be implemented in the context of an e-commerce platform, or may be made available for use outside of the e-commerce platform.

Some examples described herein may be described in the context of email communications. However, it should be understood that different forms of electronic communications (e.g., email, text messaging, social media private or public messages, etc.) may be within the scope of the present disclosure.

In some examples, the present disclosure describes a system including a processing device in communication with a storage. The processing device is configured to execute instructions to cause the system to: receive, from a sender account, a set of parameters for a proposed messaging campaign, the set of parameters including a set of intended recipients; determine, based on a trust indicator associated with the proposed messaging campaign, that the proposed messaging campaign should be blocked; and transmit at least one tracked message to at least one selected recipient from the set of intended recipients, the at least one tracked message being at least a subset of messages for the proposed messaging campaign.

In some examples, the present disclosure describes a method including: receiving, from a sender account, a set of parameters for a proposed messaging campaign, the set of parameters including a set of intended recipients; determining, based on a trust indicator associated with the proposed messaging campaign, that the proposed messaging campaign should be blocked; and transmitting at least one tracked message to at least one selected recipient from the set of intended recipients, the at least one tracked message being at least a subset of messages for the proposed messaging campaign.

In some examples, the present disclosure describes a computer readable medium having computer-executable instructions stored thereon. The instructions, when executed by a processing device of a system, cause the system to: receive, from a sender account, a set of parameters for a proposed messaging campaign, the set of parameters including a set of intended recipients; determine, based on a trust indicator associated with the proposed messaging campaign, that the proposed messaging campaign should be blocked; and transmit at least one tracked message to at least one selected recipient from the set of intended recipients, the at least one tracked message being at least a subset of messages for the proposed messaging campaign.

In any of the above examples, at least one message may be transmitted to at least one remainder recipient from the set of intended recipients when a rejection metric associated with the at least one tracked message passes a rejection threshold.

In any of the above examples, the rejection metric may be determined to pass the rejection threshold by at least one of: tracking a blocking of the at least one tracked message by an external messaging service; tracking a delivery failure of the at least one tracked message; or tracking a negative recipient response to the at least one tracked message.

In any of the above examples, an algorithm for computing a trust value for the trust indicator may be updated, based on the rejection metric.

In any of the above examples, the algorithm may be learned using a machine-learning sub-system. Updating the algorithm may include: including the rejection metric in a training dataset; and updating the algorithm, using the training dataset to train the machine-learning sub-system.

In any of the above examples, the at least one selected recipient may be selected based on a relationship level between the at least one selected recipient and the sender account, or between the at least one selected recipient and an online store associated with the sender account.

In any of the above examples, a trust value may be computed for the trust indicator based on the set of parameters; and it may be determined that the proposed messaging campaign should be blocked when the trust value fails a trust threshold.

In any of the above examples, it may be determined that the proposed messaging campaign should be allowed when the trust value computed passes the trust threshold, and in response, at least one message may be transmitted to each recipient in the set of intended recipients.

In any of the above examples, a plurality of proposed messaging campaigns may be managed. Tracked messages may be transmitted to selected recipients across the plurality of proposed messaging campaigns, where the tracked messages may total a defined quantity.

### BRIEF DESCRIPTION OF THE DRAWINGS

Reference will now be made, by way of example, to the accompanying drawings which show example embodiments of the present application, and in which:

FIG. 1 is a block diagram of an example e-commerce platform, in which examples described herein may be implemented;

FIG. 2 is an example homepage of an administrator, which may be accessed via the e-commerce platform of FIG. 1;

FIG. 3 is another block diagram of the e-commerce platform of FIG. 1, showing some details related to application development;

FIG. 4 shows an example data flow that may take place when a purchase is made using the e-commerce platform of FIG. 1;

FIG. 5 is a block diagram illustrating an example implementation of the e-commerce platform of FIG. 1;

FIG. 6 is another block diagram of the e-commerce platform of FIG. 1, showing some details related to a messaging campaign engine; and

FIG. 7 is a flowchart illustrating an example method for managing blocking and unblocking of a proposed messaging campaign.

Similar reference numerals may have been used in different figures to denote similar components.

### DESCRIPTION OF EXAMPLE EMBODIMENTS

The present disclosure will be described in the context of an e-commerce platform, discussed below. However, it should be understood that this discussion is only for the purpose of illustration and is not intended to be limiting. Further, it should be understood that the present disclosure may be implemented in other contexts, and is not necessarily limited to implementation in an e-commerce platform.

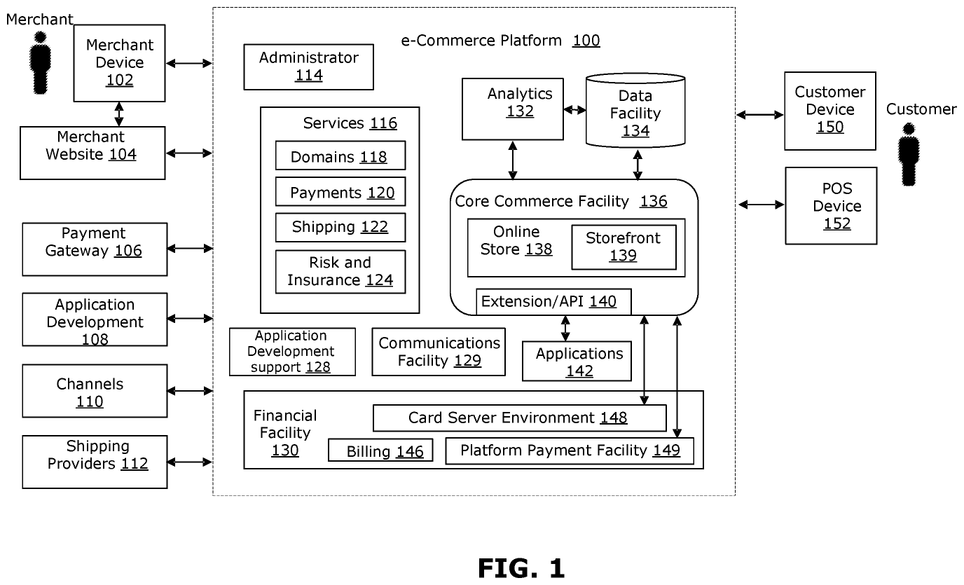

With reference to FIG. 1, an embodiment e-commerce platform 100 is depicted for providing merchant products and services to customers. While the disclosure throughout contemplates using the apparatus, system, and process disclosed to purchase products and services, for simplicity the description herein will refer to products or offerings. All references to products or offerings throughout this disclosure should also be understood to be references to products and/or services, including physical products, digital content, tickets, subscriptions, services to be provided, and the like.

While the disclosure throughout contemplates that a “merchant”, a “marketer” and a “customer” may be more than individuals, for simplicity the description herein may generally refer to merchants, marketers and customers as such. All references to merchants, marketers and customers throughout this disclosure should also be understood to be references to groups of individuals, companies, corporations, computing entities, and the like, and may represent for-profit or not-for-profit exchange of products. Further, while the disclosure throughout refers to “merchants”, “marketers” and “customers”, and describes their roles as such, it should be understood that aspects of the e-commerce platform 100 may be more generally available to support users in an e-commerce environment, and all references to merchants, marketers and customers throughout this disclosure should also be understood to be references to users, such as where a user is a merchant-user (e.g., a seller, retailer, wholesaler, or provider of products), a marketer-user (e.g., a marketing agent, an external marketing service provider, or a self-marketing merchant), a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Further, it should be understood that any individual or group of individuals may play more than one role and may fit more than one label in the e-commerce environment. For example, a merchant may also be a marketer, or a corporate user may also be a customer.

The e-commerce platform 100 may provide a centralized system for providing merchants with online resources for managing their business. Merchants may utilize the e-commerce platform 100 for managing commerce with customers, such as by implementing an e-commerce experience with customers through an online store 138, through channels 110, through point of sale (POS) devices 152 in physical locations (e.g., a physical storefront or other location such as through a kiosk, terminal, reader, printer, 3D printer, and the like), by managing their business through the e-commerce platform 100, by interacting with customers through a communications facility 129 of the e-commerce platform 100, or any combination thereof.

The online store 138 may represent a multitenant facility comprising a plurality of virtual storefronts 139. In various embodiments, merchants may manage one or more storefronts 139 in the online store 138, such as through a merchant device 102 (e.g., computer, laptop computer, mobile computing device, and the like), and offer products to customers through a number of different channels 110 (e.g., an online store 138; a physical storefront through a POS device 152; electronic marketplace, through an electronic buy button integrated into a website or social media channel such as on a social network, social media page, social media messaging system; and the like). A merchant may sell across channels 110 and then manage their sales through the e-commerce platform 100. A merchant may sell in their physical retail store, at pop ups, through wholesale, over the phone, and the like, and then manage their sales through the e-commerce platform 100. A merchant may employ all or any combination of these, such as maintaining a business through a physical storefront utilizing POS devices 152, maintaining a virtual storefront 139 through the online store 138, and utilizing the communications facility 129 to leverage customer interactions and analytics 132 to improve the probability of sales, for example.

In various embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable merchants to reach customers through the online store 138, through POS devices 152 in physical locations (e.g., a merchant's storefront or elsewhere), to promote commerce with customers through dialog via electronic communication, and the like, providing a system for reaching customers and facilitating merchant services for the real or virtual pathways available for reaching and interacting with customers.

In various embodiments, and as described further herein, the e-commerce platform 100 may be implemented through a processing facility including a processing device and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, merchant devices 102, payment gateways 106, application development 108, channels 110, shipping providers 112, customer devices 150, POS devices 152, and the like. The e-commerce platform 100 may be implemented as a cloud computing service, a software as a service (SaaS), infrastructure as a service (IaaS), platform as a service (PaaS), desktop as a Service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a thin client via a web browser, accessed through by POS devices, and the like). In various embodiments, elements of the e-commerce platform 100 may be implemented to operate on various platforms and operating systems, such as iOS, Android, over the internet, and the like.

In various embodiments, storefronts 139 may be served by the e-commerce platform 100 to customers (e.g., via customer devices 150), where customers can browse and purchase the various products available (e.g., add them to a cart, purchase immediately through a buy-button, and the like). Storefronts 139 may be served to customers in a transparent fashion without customers necessarily being aware that it is being provided through the e-commerce platform 100 (rather than directly from the merchant). Merchants may use a merchant configurable domain name, a customizable HTML theme, and the like, to customize their storefront 139. Merchants may customize the look and feel of their website through a theme system, such as where merchants can select and change the look and feel of their storefront 139 by changing their theme while having the same underlying product and business data shown within the storefront's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a basic content management system for website content. Merchants may author blog posts or static pages and publish them to their storefront 139 and/or website 104, such as through blogs, articles, and the like, as well as configure navigation menus. Merchants may upload images (e.g., for products), video, content, data, and the like to the e-commerce platform 100, such as for storage by the system. In various embodiments, the e-commerce platform 100 may provide functions for resizing images, associating an image with a product, adding and associating text with an image, adding an image for a new product variant, protecting images, and the like.

As described herein, the e-commerce platform 100 may provide merchants with transactional facilities for products through a number of different channels 110, including the online store 138, over the telephone, as well as through physical POS devices 152 as described herein. The e-commerce platform 100 may provide business support services 116, an administrator component 114, and the like associated with running an online business, such as providing a domain service 118 associated with their online store, payments services 120 for facilitating transactions with a customer, shipping services 122 for providing customer shipping options for purchased products, risk and insurance services 124 associated with product protection and liability, merchant billing services 146, and the like. Services 116 may be provided via the e-commerce platform 100 or in association with external facilities, such as through a payment gateway 106 for payment processing, shipping providers 112 for expediting the shipment of products, and the like.

In various embodiments, the e-commerce platform 100 may provide for integrated shipping services 122 (e.g., through an e-commerce platform shipping facility or through a third-party shipping carrier), such as providing merchants with real-time updates, tracking, automatic rate calculation, bulk order preparation, label printing, and the like.

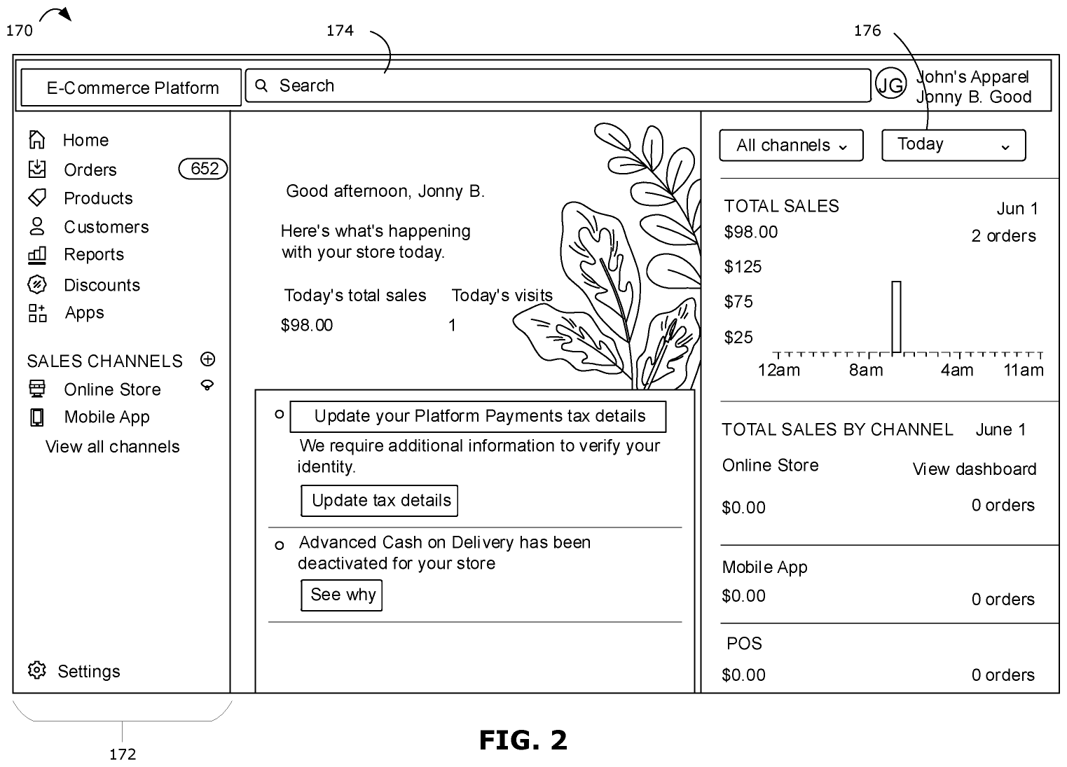

FIG. 2 depicts a non-limiting embodiment for a home page 170 of an administrator 114, which may show information about daily tasks, a store's recent activity, and the next steps a merchant can take to build their business. In various embodiments, a merchant may log in to administrator 114, such as from a browser or mobile device, and manage aspects of their storefront, such as viewing the storefront's recent activity, updating the storefront's catalog, managing orders, recent visits activity, total orders activity, and the like. In various embodiments, the merchant may be able to access the different sections of administrator 114 by using the sidebar 172, such as shown on FIG. 2. Sections of the administrator may include core aspects of a merchant's business, including orders, products, and customers; sales channels, including the online store, POS, and buy button; applications installed on the merchant's account; settings applied to a merchant's storefront 139 and account. A merchant may use a search bar 174 to find products, pages, or other information. Depending on the device the merchant is using, they may be enabled for different functionality through the administrator 114. For instance, if a merchant logs in to the administrator 114 from a browser, they may be able to manage all aspects of their storefront 139. If the merchant logs in from their mobile device, they may be able to view all or a subset of the aspects of their storefront 139, such as viewing the storefront's recent activity, updating the storefront's catalog, managing orders, and the like.

More detailed information about commerce and visitors to a merchant's storefront 139 may be viewed through acquisition reports or metrics, such as displaying a sales summary for the merchant's overall business, specific sales and engagement data for active sales channels, and the like. Reports may include, acquisition reports, behavior reports, customer reports, finance reports, marketing reports, sales reports, custom reports, and the like. The merchant may be able to view sales data for different channels 110 from different periods of time (e.g., days, weeks, months, and the like), such as by using drop-down menus 176. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's storefront 139, such as based on account status, growth, recent customer activity, and the like. Notifications may be provided to assist a merchant with navigating through a process, such as capturing a payment, marking an order as fulfilled, archiving an order that is complete, and the like.

Reference is made back to FIG. 1. The e-commerce platform may provide for a communications facility 129 and associated merchant interface for providing electronic communications and marketing, such as utilizing an electronic messaging aggregation facility (not shown) for collecting and analyzing communication interactions between merchants, customers, merchant devices 102, customer devices 150, POS devices 152, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 129 analyzes the interaction and provides analysis to the merchant on how to improve the probability for a sale.

The e-commerce platform 100 may provide a financial facility 130 for secure financial transactions with customers, such as through a secure card server environment 148. The e-commerce platform 100 may store credit card information, such as in payment card industry data (PCI) environments (e.g., a card server), to reconcile financials, bill merchants, perform automated clearing house (ACH) transfers between an e-commerce platform 100 financial institution account and a merchant's back account (e.g., when using capital), and the like. These systems may have Sarbanes-Oxley Act (SOX) compliance and a high level of diligence required in their development and operation. The financial facility 130 may also provide merchants with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They also may connect and onboard new merchants with the e-commerce platform 100. These services may enable merchant growth by making it easier for merchants to work across the e-commerce platform 100. Through these services, merchants may be provided help facilities via the e-commerce platform 100.

In various embodiments, online store 138 may support a great number of independently administered storefronts 139 and process a large volume of transactional data on a daily basis for a variety of products. Transactional data may include customer contact information, billing information, shipping information, information on products purchased, information on services rendered, and any other information associated with business through the e-commerce platform 100. In various embodiments, the e-commerce platform 100 may store this data in a data facility 134. The transactional data may be processed to produce analytics 132, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 100 may store information about business and merchant transactions, and the data facility 134 may have many ways of enhancing, contributing, refining, and extracting data, where over time the collected data may enable improvements to aspects of the e-commerce platform 100.

In various embodiments, the e-commerce platform 100 may be configured with a core commerce facility 136 for content management and task automation to enable support and services to the plurality of storefronts 139 (e.g., related to products, inventory, customers, orders, collaboration, suppliers, reports, financials, risk and fraud, and the like), but be extensible through applications 142 that enable greater flexibility and custom processes required for accommodating an ever-growing variety of merchant storefronts 139, POS devices 152, products, and services. For instance, the core commerce facility 136 may be configured for flexibility and scalability through portioning (e.g., sharding) of functions and data, such as by customer identifier, order identifier, storefront identifier, and the like. The core commerce facility 136 may accommodate store-specific business logic and a web administrator. The online store 138 may represent a channel, be embedded within the core commerce facility 136, provide a set of support and debug tools that support uses for merchants, and the like. The core commerce facility 136 may provide centralized management of critical data for storefronts 139.

The core commerce facility 136 includes base or “core” functions of the e-commerce platform 100, and as such, as described herein, not all functions supporting storefronts 139 may be appropriate for inclusion. For instance, functions for inclusion into the core commerce facility 136 may need to exceed a core functionality threshold through which it may be determined that the function is core to a commerce experience (e.g., common to a majority of storefront activity, such as across channels, administrator interfaces, merchant locations, industries, product types, and the like), is re-usable across storefronts (e.g., functions that can be re-used/modified across core functions), limited to the context of a single storefront at a time (e.g., implementing a storefront ‘isolation principle’, where code should not be able to interact with multiple storefronts at a time, ensuring that storefronts cannot access each other's data), provide a transactional workload, and the like. Maintaining control of what functions are implemented may enable the core commerce facility 136 to remain responsive, as many required features are either served directly by the core commerce facility 136 or enabled by its extension/application programming interface (API) 140 connection to applications 142. If care is not given to restricting functionality in the core commerce facility 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the core commerce facility 136 may be configured to maintain responsiveness, such as through configuration that utilizes timeouts, queues, back-pressure to prevent degradation, and the like.

Although isolating storefront data is important to maintaining data privacy between storefronts 139 and merchants, there may be reasons for collecting and using cross-store data, such as for example, with an order risk assessment system or a platform payment facility, both of which require information from a majority of storefronts 139 to perform well. In various embodiments, rather than violating the isolation principle, it may be preferred to move these components out of the core commerce facility 136 and into their own infrastructure within the e-commerce platform 100. For example, the data facility 134 and analytics 132 may be located outside the core commerce facility 136.

In various embodiments, the e-commerce platform 100 may provide for a platform payment facility 149, which is another example of a component that utilizes data from the core commerce facility 138 but may be located outside so as to not violate the isolation principle. The platform payment facility 149 may allow customers interacting with storefronts 139 to have their payment information stored safely by the core commerce facility 136 such that they only have to enter it once. When a customer visits a different storefront 139, even if they've never been there before, the platform payment facility 149 may recall their information to enable a more rapid and correct check out. This may provide a cross-platform network effect, where the e-commerce platform 100 becomes more useful to its merchants as more merchants join, such as because there are more customers who checkout more often because of the ease of use with respect to customer purchases. To maximize the effect of this network, payment information for a given customer may be retrievable from a storefront's checkout, allowing information to be made available globally across storefronts 139. It would be difficult and error prone for each storefront 139 to be able to connect to any other storefront 139 to directly retrieve the payment information stored there. As a result, the platform payment facility 149 may be implemented external to the core commerce facility 136.

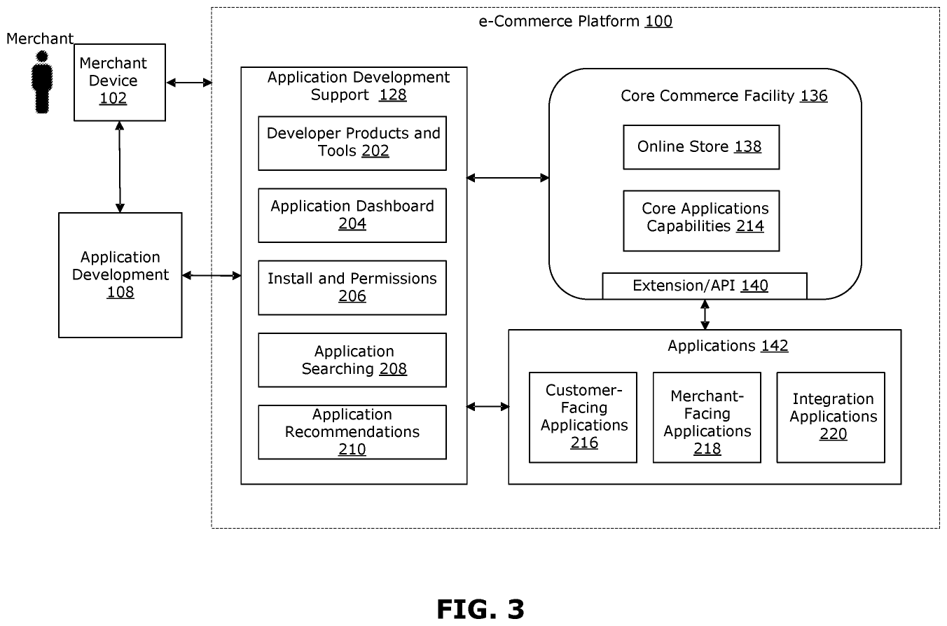

For those functions that are not included within the core commerce facility 138, applications 142 provide a way to add features to the e-commerce platform 100. Applications 142 may be able to access and modify data on a merchant's storefront 139, perform tasks through the administrator 114, create new flows for a merchant through a user interface (e.g., that is surfaced through extensions/API 140), and the like. Merchants may be enabled to discover and install applications 142 through application searching 208 and application recommendations 210 (see FIG. 3). In various embodiments, core products, core extension points, applications, and the administrator 114 may be developed to work together. For instance, application extension points may be built inside the administrator 114 so that core features may be extended by way of applications 142, which may deliver functionality to a merchant through the extension/API 140.

In various embodiments, applications 142 may deliver functionality to a merchant through the extension/API 140, such as where an application 142 is able to surface transaction data to a merchant (e.g., App: “Surface my app in mobile and web admin using the embedded app SDK”), and/or where the core commerce facility 136 is able to ask the application to perform work on demand (core: “App, give me a local tax calculation for this checkout”).

Applications 142 may support storefronts 139 and channels 110, provide merchant support, integrate with other services, and the like. Where the core commerce facility 136 may provide the foundation of services to the storefront 139, the applications 142 may provide a way for merchants to satisfy specific and sometimes unique needs. Different merchants will have different needs, and so may benefit from different applications 142. Applications 142 may be better discovered through the e-commerce platform 100 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 142 may be connected to the core commerce facility 136 through an extension/API layer 140, such as utilizing APIs to expose the functionality and data available through and within the core commerce facility 136 to the functionality of applications (e.g., through REST, GraphQL, and the like). For instance, the e-commerce platform 100 may provide API interfaces to merchant and partner-facing products and services, such as including application extensions, process flow services, developer-facing resources, and the like. With customers more frequently using mobile devices for shopping, applications 142 related to mobile use may benefit from more extensive use of APIs to support the related growing commerce traffic. The flexibility offered through use of applications and APIs (e.g., as offered for application development) enable the e-commerce platform 100 to better accommodate new and unique needs of merchants (and internal developers through internal APIs) without requiring constant change to the core commerce facility 136, thus providing merchants what they need when they need it. For instance, shipping services 122 may be integrated with the core commerce facility 136 through a shipping or carrier service API, thus enabling the e-commerce platform 100 to provide shipping service functionality without directly impacting code running in the core commerce facility 136.

Many merchant problems may be solved by letting partners improve and extend merchant workflows through application development, such as problems associated with back-office operations (merchant-facing applications) and in the storefront (customer-facing applications). As a part of doing business, many merchants will use mobile and web related applications on a daily basis for back-office tasks (e.g., merchandising, inventory, discounts, fulfillment, and the like) and storefront tasks (e.g., applications related to their online shop, for flash-sales, new product offerings, and the like), where applications 142, through extension/API 140, help make products easy to view and purchase in a fast growing marketplace. In various embodiments, partners, application developers, internal applications facilities, and the like, may be provided with a software development kit (SDK), such as through creating a frame within the administrator 114 that sandboxes an application interface. In various embodiments, the administrator 114 may not have control over nor be aware of what happens within the frame. The SDK may be used in conjunction with a user interface kit to produce interfaces that mimic the look and feel of the e-commerce platform 100, such as acting as an extension of the core commerce facility 136.

Applications 142 that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the core commerce facility 136, such as for synchronizing a local database, notifying an external integration partner, and the like. Update events may enable this functionality without having to poll the core commerce facility 136 all the time to check for updates, such as through an update event subscription. In various embodiments, when a change related to an update event subscription occurs, the core commerce facility 136 may post a request, such as to a defined callback URL. The body of this request may contain a new state of the object and a description of the action or event. Update event subscriptions may be created manually, in the administrator facility 114, or automatically (e.g., via the API). In various embodiments, update events may be queued and processed asynchronously from a state change that triggered them, which may produce an update event notification that is not distributed in real-time.

Reference is made to FIG. 3, which is another depiction of the e-commerce platform 100. FIG. 3 omits some details that have been described with reference to FIG. 1, and shows further details discussed below. In various embodiments, the e-commerce platform 100 may provide application development support 128. Application development support 128 may include developer products and tools 202 to aid in the development of applications, an application dashboard 204 (e.g., to provide developers with a development interface, to administrators for management of applications, to merchants for customization of applications, and the like), facilities for installing and providing permissions 206 with respect to providing access to an application 142 (e.g., for public access, such as where criteria must be met before being installed, or for private use by a merchant), application searching 208 to make it easy for a merchant to search for applications 142 that satisfy a need for their storefront 139, application recommendations 210 to provide merchants with suggestions on how they can improve the user experience through their storefront 139, a description of core application capabilities 214 within the core commerce facility 136, and the like. These support facilities may be utilized by application development 108 performed by any entity, including the merchant developing their own application 142, a third-party developer developing an application 142 (e.g., contracted by a merchant, developed on their own to offer to the public, contracted for use in association with the e-commerce platform 100, and the like), or an application being developed by internal personal resources associated with the e-commerce platform 100. In various embodiments, applications 142 may be assigned an application identifier (ID), such as for linking to an application (e.g., through an API), searching for an application, making application recommendations, and the like.

The core commerce facility 136 may include base functions of the e-commerce platform 100 and expose these functions through APIs to applications 142. The APIs may enable different types of applications built through application development 108. Applications 142 may be capable of satisfying a great variety of needs for merchants but may be grouped roughly into three categories: customer-facing applications 216, merchant-facing applications 218, or integration applications 220. Customer-facing applications 216 may include storefront 139 or channels 110 that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 218 may include applications that allow the merchant to administer their storefront 139 (e.g., through applications related to the web or website or to mobile devices), run their business (e.g., through applications related to POS devices 152), to grow their business (e.g., through applications related to shipping (e.g., drop shipping), use of automated agents, use of process flow development and improvements), and the like. Integration applications 220 may include applications that provide useful integrations that participate in the running of a business, such as shipping providers 112 and payment gateways.

In various embodiments, an application developer may use an application proxy to fetch data from an outside location and display it on the page of an online storefront 139. Content on these proxy pages may be dynamic, capable of being updated, and the like. Application proxies may be useful for displaying image galleries, statistics, custom forms, and other kinds of dynamic content. The core-application structure of the e-commerce platform 100 may allow for an increasing number of merchant experiences to be built in applications 142 so that the core commerce facility 136 can remain focused on the more commonly utilized business logic of commerce.

The e-commerce platform 100 provides an online shopping experience through a curated system architecture that enables merchants to connect with customers in a flexible and transparent manner. A typical customer experience may be better understood through an embodiment example purchase workflow, where the customer browses the merchant's products on a channel 110, adds what they intend to buy to their cart, proceeds to checkout, and pays for the content of their cart resulting in the creation of an order for the merchant. The merchant may then view and fulfill (or cancel) the order. The product is then delivered to the customer. If the customer is not satisfied, they might return the products to the merchant.

In an example embodiment, a customer may browse a merchant's products on a channel 110. A channel 110 is a place where customers can view and buy products. In various embodiments, channels 110 may be modeled as applications 142 (a possible exception being the online store 138, which is integrated within the core commence facility 136). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In various embodiments, the customer may add what they intend to buy to their cart (in an alternate embodiment, a product may be purchased directly, such as through a buy button as described herein). Customers may add product variants to their shopping cart. The shopping cart model may be channel specific. The online store 138 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the expected lifespan of a cart may be in the order of minutes (not days), carts may be persisted to an ephemeral data store.

The customer then proceeds to checkout. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer inputs their contact information but does not proceed to payment, the e-commerce platform 100 may provide an opportunity to re-engage the customer (e.g., in an abandoned checkout feature). For those reasons, checkouts can have much longer lifespans than carts (hours or even days) and are therefore persisted. Checkouts may calculate taxes and shipping costs based on the customer's shipping address. Checkout may delegate the calculation of taxes to a tax component and the calculation of shipping costs to a delivery component. A pricing component may enable merchants to create discount codes (e.g., “secret” strings that when entered on the checkout apply new prices to the items in the checkout). Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10”, and entitlements may be items such as “a 20% discount on the whole order” or “$10 off products X, Y, and Z”.

Customers then pay for the content of their cart resulting in the creation of an order for the merchant. Channels 110 may use the core commerce facility 136 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 106 may be provided through the card server environment 148. In various embodiments, the payment gateway 106 may accept international payment, such as integrating with leading international credit card processors. The card server environment 148 may include a card server application, card sink, hosted fields, and the like. This environment may act as the secure gatekeeper of the sensitive credit card information.

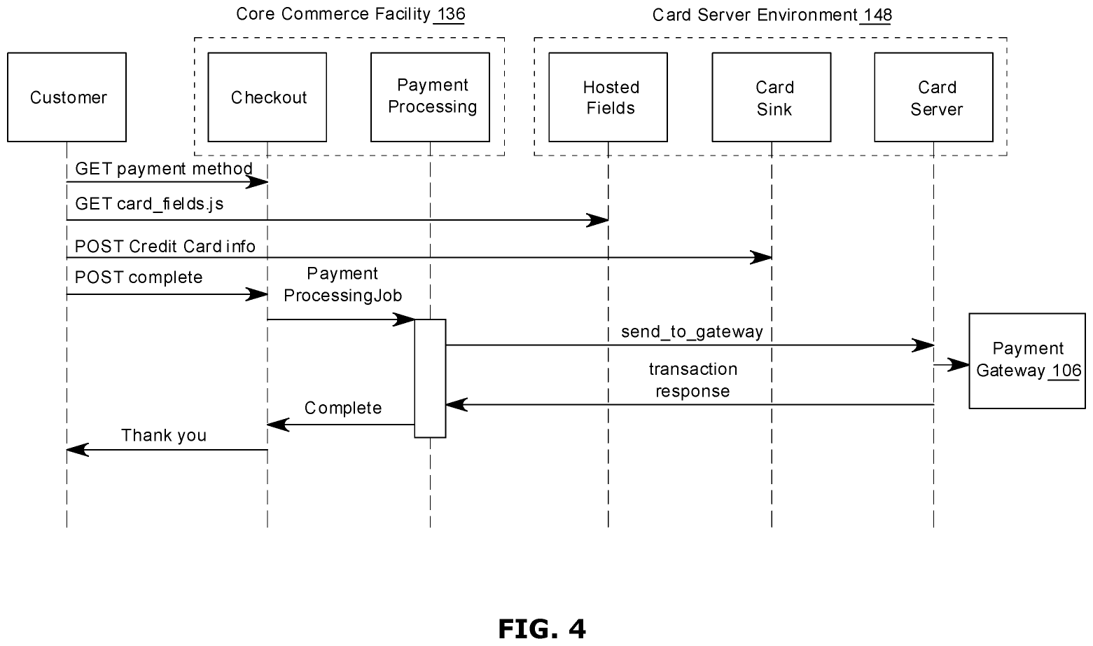

FIG. 4 presents, in a non-limiting example, a simplified sequence diagram of the interactions between the core commerce facility 136 and the card server environment 148 during payment processing of a credit, prepaid, gift or other card on a Web Checkout.

In various embodiments, most of the process may be orchestrated by a payment processing job. The core commerce facility 136 may support many other payment methods, such as through an offsite payment gateway 106 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 110 that do not rely on core commerce facility checkouts may use an order API to create orders. Once an order is created, an order confirmation notification may be sent to the customer and an order placed notification sent to the merchant via a notifications component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location. An inventory component may record where variants are stocked, and tracks quantities for variants that have inventory tracking enabled. It may decouple product variants (a customer facing concept representing the template of a product listing) from inventory items (a merchant facing concept that represent an item whose quantity and location is managed). An inventory level component may keep track of quantities that are available for sale, committed to an order or incoming from an inventory transfer component (e.g., from a vendor). The merchant may then view and fulfill (or cancel) the order.

An order assessment component may implement a business process merchants use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In various embodiments, this business process may be implemented by a fulfillment component. The fulfillment component may group the line items of the order into a logical fulfillment unit of work based on an inventory location and fulfillment service. The merchant may assess the order, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that does not provide an API connection). An API fulfillment service may trigger a third party, where the third-party application creates a fulfillment record. A legacy fulfillment service may trigger a custom API call from the core commerce facility 136 to a third party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a returns component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that were not returned and remain in the customer's hands); and the like. A return may represent a change to the contract of sale (e.g., the order), and where the e-commerce platform 100 may make the merchant aware of compliance issues with respect to legal obligations (e.g., with respect to taxes). In various embodiments, the e-commerce platform 100 may enable merchants to keep track of changes to the contract of sales over time, such as implemented through a sales model component (e.g., an append-only date-based ledger that records sale-related events that happened to an item).

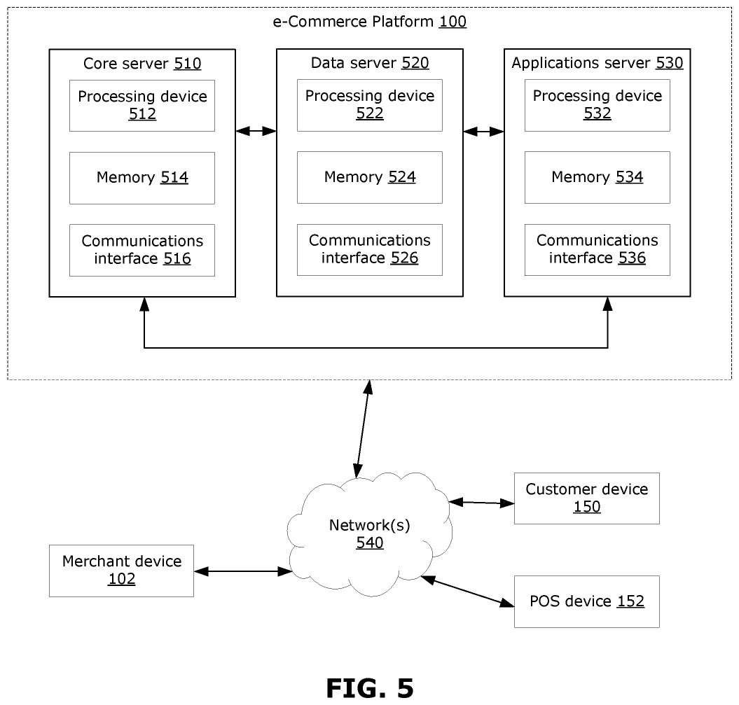

FIG. 5 is a block diagram of an example hardware configuration of the e-commerce platform 100. It should be noted that different components of the e-commerce platform 100 (e.g., the data facility 134, analytics facility 132, core commerce facility 136 and applications 142) may be implemented in separate hardware or software components, on a common hardware component or server or configured as a common (integrated) service or engine in the e-commerce platform 100. In the example of FIG. 5, the e-commerce platform 100 includes a core server 510, a data server 520 and an applications server 530, which are each in communication with each other (e.g., via wired connections and/or via wireless intranet connections). Each of the servers 510, 520, 530 include a respective processing device 512, 522, 532 (each of which may be, for example, a microprocessor, graphical processing unit, digital signal processor or other computational element), a respective memory 514, 524, 534 (each of which may be, for example, random access memory (RAM), read only memory (ROM), hard disk, optical disc, subscriber identity module (SIM) card, memory stick, secure digital (SD) memory card, and the like, and may include tangible or transient memory), and a respective communications interface 516, 526, 536 (each of which may include transmitter, receiver and/or transceiver for wired and/or wireless communications). The core server 510 may store instructions and perform operations relevant to core capabilities of the e-commerce platform, such as providing the administrator 114, analytics 132, core commerce facility 136, services 116 and/or financial facility 130, among others. The data server 520 may be used to implement the data facility 134, among others. The applications server 530 may store instructions and perform operations relevant to the applications 142, such as storing instructions and data for the applications 142 and for implementing application development support 128.

Merchants and customers, using respective devices 102, 150, 152 may access the e-commerce platform 100 via one or more networks 540 (e.g., wired and/or wireless networks, including a virtual private network (VPN), the Internet, and the like).

Although FIG. 5 illustrates an example hardware implementation of the e-commerce platform 100, it should be understood that other implementations may be possible. For example, there may be greater or fewer numbers of servers, the e-commerce platform 100 may be implemented in a distributed manner, or at least some of the memories 514, 524, 534 may be replaced with external storage or cloud-based storage, among other possible modifications.

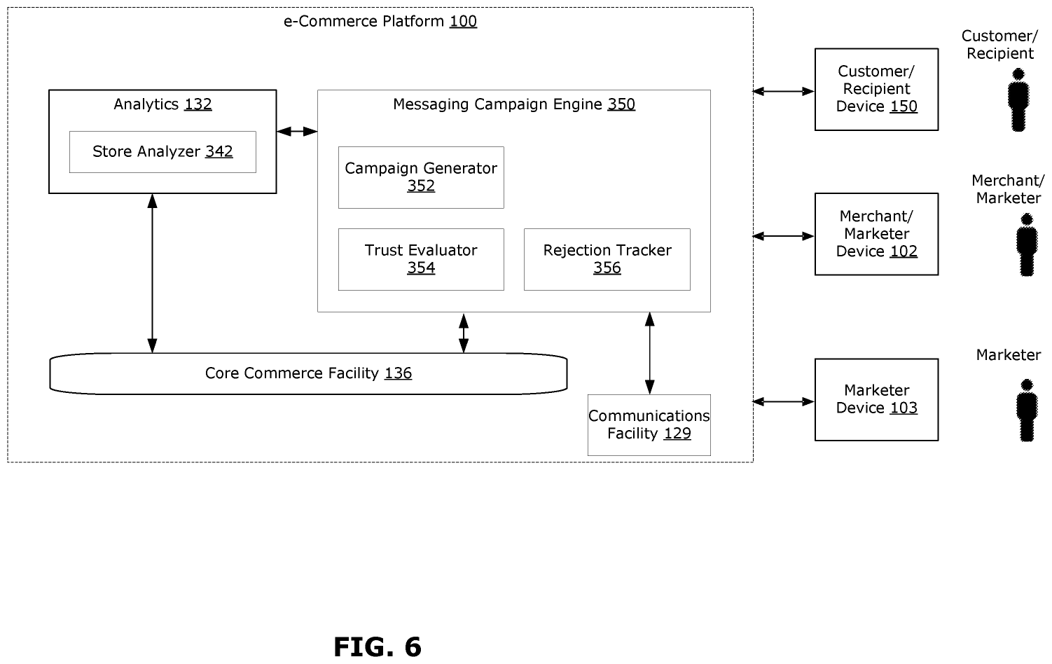

FIG. 6 is another depiction of the e-commerce platform 100 that omits some details that have been described with reference to FIG. 1, and shows further details discussed below. In particular, FIG. 6 illustrates some details of the e-commerce platform 100 that are relevant to managing a messaging campaign.

A messaging campaign (which may also be referred to as a marketing campaign in some implementations), in the present disclosure, may refer to a set of one or more electronic messages (e.g., email, text, audio, video or multimedia messages) that are sent to a set of intended recipients. Typically, all intended recipients receive messages having the same or similar content, although there may be some variation to tailor messages to individual recipients and/or variation over different phases of the messaging campaign. A messaging campaign may be used for promotion (e.g., to promote a service, a product, a store, a merchant, a person, etc.), for providing information (e.g., to provide a mass announcement, mass notification, etc.), for obtaining information (e.g., to send out a survey, to request a reply, to request a confirmation, etc.), or other such purposes. As will be discussed further below, a messaging campaign is typically defined by a set of parameters that define the form of the campaign, the content of the messages and the intended recipients, among other possible parameters.

In the context of a messaging campaign, a customer of the e-commerce platform 100 may also be a recipient who is an intended recipient of a directed messaging campaign. Accordingly, FIG. 6 illustrates the customer as a customer/recipient, and the customer/recipient may interact with the e-commerce platform 100 via the customer/recipient device 150. However, it should be understood that not all customers of a merchant using the e-commerce platform 100 may be a recipient of a messaging campaign, and not all recipients of a messaging campaign may be customers of a merchant using the e-commerce platform 100. For generality, the present disclosure will refer to “recipients” of a directed messaging campaign. In cases where a recipient is not a current customer of merchant that uses the e-commerce platform 100, the e-commerce platform 100 may nonetheless obtain at least generalized information about the online behavior of the non-customer recipient, for example via anonymized statistical data and/or via user-consented sharing of information with a social media platform, among other possibilities.

In the context of a messaging campaign, a merchant on the e-commerce platform 100 may also be a marketer who is planning a messaging campaign. Accordingly, FIG. 6 illustrates the merchant as a merchant/marketer, and the merchant/marketer may interact with the e-commerce platform via the merchant/marketer device 102. Additionally, a marketer (who is not also a merchant on the e-commerce platform 100) may interact with the e-commerce platform 100 via a marketer device 103. Such a marketer may, for example, use certain services provided by the e-commerce platform 100, such as for generating a messaging campaign as discussed below, without having to be a customer or merchant who is subscribed to the e-commerce platform 100. In some examples, the e-commerce platform 100 may make certain services/applications, such as the dynamic campaign engine 350 discussed below, accessible to users as standalone services/applications.

The analytics facility 132 in this example includes a store analyzer 342, which may be implemented as a sub-module of the analytics facility 132 or may be implemented as part of the general functions of the analytics facility 132. The store analyzer 342 serves to analyze available data of online stores, as well as online behavior of both merchants and customers. In some examples, some or all functions of the store analyzer 342 may be implemented using a machine-learning system.

The store analyzer 342 serves to analyze available data of one or more online stores 138, in order to determine if an online store 138 has legitimate configuration data and/or online sales, among other possibilities. The store analyzer 342 may generate information that may be used to determine trustworthiness of an online store 138 or a merchant associated with the online store 138, for example. The store analyzer 342 can query data facility 134 (FIG. 1) to obtain information regarding a specific online store 138 based on an identification of a merchant. For example, a merchant may have a user account; the user account may have a user identifier (ID). The merchant may have one or more online stores 138, and each of the one or more online stores 138 is associated independently with the user ID. Each online store 138 may have a store ID, and has various information stored in the data facility 134 under the store ID. An online store 138 may support one or more independently administered storefronts 139, where a storefront 139 may be represented by a URL; that is, an online store 138 having a store ID may have one or more URLs, with each URL configured for a different storefront 139. All of the URLs under the same store ID may be stored in the data facility 134. A store analyzer 342 may query the data facility 134 to obtain one or more URLs stored under a specific store ID that is linked to a specific user ID of a merchant. An online store 138 may have a number of store configurations and/or customizations in place in order to process transactions. For instance, in order to process a sales transaction, ship and deliver goods or products, and/or receive proceeds of sales from the sales transaction, an online store 138 needs to have a financial transaction configuration in place, including a payment gateway or rail (e.g. credit card, Apple Pay(®), PayPal®, etc.) as well as bank deposit information. In addition, the online store 138 needs to have one or more product offerings listed in a storefront 139, and each listed product offering needs to have an associated inventory count thereof. The financial transaction configuration information, the product offering listings, as well as the individual inventory count for each product offering may be stored in the data facility 134 under a specific store ID and in turn linked to a specific user ID. The online store 138 also may have a delivery configuration set up in place for shipping and delivering the ordered product offerings to the customers. The delivery configuration may include at least a default shipping method (e.g. FedEx®) as well as associated shipping charges. The delivery configuration may be stored in the data facility 134 under a specific store ID and in turn linked to a specific user ID. When the store analyzer 342 queries the data facility 134 based on a user ID of an user account of a merchant, the store analyzer 342 may be able to access a number of information regarding one or more online stores 138 of a specific merchant linked to the user ID, including one or more URLs of the one or more online stores 138, one or more payment rails, one or more bank deposit information, one or more product listings and associated inventory count thereof, and one or more delivery configurations for each online store 138. As further explained below, the more information the store analyzer 134 is able to find for an online store 138, the more legitimate the online store 138 (and its associated merchant) appears to be.

In various embodiments, the online store 138 may support a plurality of independently administered storefronts 139 and may process a volume of transactional data on a regular (e.g., daily) basis for a variety of products. Transactional data may include customer contact information, billing information, shipping information, information on products purchased, information on services rendered, and any other information associated with business through the e-commerce platform 100. In various embodiments, the e-commerce platform 100 may store this data in the data facility 134. The store analyzer 342 may thus further query the data facility 134 to obtain sales volume of one or more product offerings in an online store 138 associated with a specific user ID of a merchant.

The e-commerce platform 100 in this example also includes a messaging campaign engine 350. The messaging campaign engine 350 may be part of the applications 142 or services 116 of the e-commerce platform 100 for example, or may be a standalone component of the e-commerce platform 100. The messaging campaign engine 350 may, for example, be implemented by the applications server 530 of FIG. 5. In other implementations, the messaging campaign engine 350 is implemented as a standalone component or service external to the e-commerce platform.

In the example of FIG. 6, the messaging campaign engine 350 includes a campaign generator 352, which may be implemented as a sub-module of the messaging campaign engine 350 or may be implemented as part of the general functions of the messaging campaign engine 350. The campaign generator 352 enables generation of a messaging campaign from one or more campaign parameters, as will be discussed further below. The messaging campaign engine 350 may communicate with the communication facility 129 or another communications interface of the e-commerce platform 100 to enable distribution of messages in accordance with a defined campaign.

A merchant or marketer may engage with the dynamic campaign engine 350 to plan and implement a messaging campaign. For simplicity, the following discussion will refer to a merchant engaging with the dynamic campaign engine 350, where the merchant is a registered user of the e-commerce platform 100 and has an account on the e-commerce platform. However, it should be understood that the following discussion may be similarly applicable in the case of a non-merchant marketer instead of a merchant/marketer, and may also be similarly applicable regardless of whether the merchant or non-merchant marketer is or is not a registered user of the e-commerce platform 100.

A messaging campaign, in the present disclosure, may be a planned set of electronic messages (which may be marketing messages, in which case the messaging campaign may also be referred to as a marketing campaign) that is communicated to certain intended recipients. In the present disclosure, a messaging campaign (and in particular a marketing campaign) may be associated with an online store (e.g., the online store 138 of the e-commerce platform 100, or an online store that is not part of the e-commerce platform 100) and/or an online merchant.

A messaging campaign may be defined by a set of campaign parameters, such as: maximum number of intended recipients (i.e., campaign size), number of phases of the campaign, a time duration for the campaign, number of different messages, a schedule for sending out messages (which may be defined in absolute terms (e.g., specific date(s) and/or time(s)), relative terms (e.g., interval of days between phases of the campaign), conditional terms (e.g., conditional on an intended recipient clicking on a link), etc.), content(s) of messages, permitted incentive inclusion (e.g., a coupon or discount), intended recipients (which may be defined as intended individuals, intended groups, intended demographics, etc.), an intended segment (e.g., age or family status), geographical region of recipients, distribution channel(s) (e.g., email, text message, social network message, etc.), an engagement level of intended recipients (e.g., only those who has previously purchased goods or services, or only those who has browsed the store 138), and a temporal range for the engagement level (e.g., only those who has engaged with the store 138 in the past month or in the past year), among other possible parameters. A distribution channel is a means of transmitting a message to an intended recipient, such as via e-mail, text message, social network message, or physical mail.

Typically, the parameters for a messaging campaign should at least define the intended recipients. In some embodiments, a set of intended recipients may be identified by recipient identifier (e.g., customer profile ID), recipient contact information (e.g., email address or phone number), demographic group (e.g., certain characteristics such as age, gender, geographical location, etc.), among other possibilities.

In some examples, the parameters for a messaging campaign may define multiple phases for conducting the campaign. For example, a campaign may be divided into multiple phases based on the schedule. For example, a first phase may communicate an initial first message to the given recipient, then according to the schedule, a second message (which may have the same content or a different content from the first message) may be communicated again to the same given recipient in a second phase of the campaign. Each campaign phase may include a maximum of n messages per intended recipient, where n is set to one or more. Often, by default, each phase of a campaign is limited to just one message per intended recipient. A user may set a number of campaign phases per intended recipient, and optionally set a schedule for the campaign phases, which includes when each phase occurs and when a message is sent to an intended recipient.

The parameters for a messaging campaign may define a time duration for the campaign. A campaign duration stipulates how long (e.g., how many days or weeks) a campaign lasts. For example, the merchant may submit a campaign duration parameter of 10 days. A campaign duration may define the total time for the campaign, including all the phases of the campaign. Alternatively or additionally, the campaign duration may define the time duration for each phase of a multi-phase campaign. The duration may be set in units of days, weeks, months, or hours, for example.

A merchant may submit one or more parameters for a proposed messaging campaign via the merchant device 102, using a user interface (e.g., an online portal) provided by the e-commerce platform 100. A proposed messaging campaign may be associated with an online store 138 managed by the merchant. Parameters for a proposed messaging campaign may be submitted by, for example, selecting from available default campaign templates and/or default campaign parameters that may be provided by the e-commerce platform 100.

The messaging campaign engine 350 uses the campaign generator 352 to define the proposed messaging campaign based on the submitted parameters. For example, the campaign generator 352 may determine that a set of user-submitted campaign parameters should be supplemented by one or more default parameters (e.g., the merchant has not submitted a proposed time duration for the messaging campaign, so the campaign generator 352 adds a default time duration as a parameter for the messaging campaign). The campaign generator 352 may also generate recommendations to change (e.g., modify, add or remove) certain proposed parameters, which may be presented to the merchant (e.g., via the merchant device 102) for approval.

The messaging campaign engine 350 uses the set of campaign parameters (after approval by the merchant, in some cases) to generate and send messages with the defined message content(s), addressed to the defined intended recipient(s), over the defined distribution channel(s), and according to the defined schedule. In some examples, the messaging campaign engine 350 may make use of message templates (which may be stored as default templates in the messaging campaign engine 350) to create message content(s). In some examples, the messaging campaign engine 350 may extract or otherwise obtain information (e.g., product information and/or contact information for individual intended recipients) from the data facility 134 or other database in order to generate the messages. For example, the messaging campaign engine 350 may use customer information stored in the data facility 134 to identify individuals that belong in the intended group (e.g., a defined demographic, such as a defined age group) defined for a messaging campaign, and generate messages to those individuals using contact information stored in the data facility 134. For privacy and security purposes, the messaging campaign engine 350 may limit the customer information extracted for a particular merchant campaign to information collected with consent (e.g. by the particular merchant and/or the platform 100) and not make such extracted information available to other merchants or third parties. The messaging campaign engine 350 may then provide the generated messages to the communications facility 129, which in turn transmits the messages to the intended recipient(s) over the defined distribution channel(s).

The messaging campaign engine 350 also performs operations to prevent generation and distribution of messages if a proposed messaging campaign is determined to be potentially spam and/or if the merchant associated with a proposed messaging campaign is determined to be a potentially bad actor. In the example shown in FIG. 6, the messaging campaign engine 350 includes a trust evaluator 354, which may be implemented as a sub-module of the messaging campaign engine 350 or may be implemented as part of the general functions of the messaging campaign engine 350. The trust evaluator 354 determines, from one or more trust indicators associated with the proposed messaging campaign, whether the proposed messaging campaign should be blocked.

A trust indicator may include a parameter of the proposed messaging campaign (e.g., proposed message content, proposed recipients, number of proposed messages, etc.), an attribute associated with the merchant (e.g., merchant history, merchant activity on the e-commerce platform, subscription level, billing history, etc.), an attribute associated with the online store 138 belonging to the merchant (e.g., historical sales activity, extent of online presence, store activity, etc.), or combinations thereof. The trust evaluator 354 may, for example, use information from the store analyzer 342 to obtain a trust indicator that is based on an attribute associated with the online store 138.

The trust evaluator 354 may implement a rules-based trust assessment algorithm, to compute a trust value using the trust indicator(s). For example, using campaign parameters as trust indicators, the trust evaluator 354 may compute a lower trust value if the message content contains certain defined words (e.g., as may be maintained in a list of disfavoured terms). In another example, using merchant attributes as trust indicators, the trust evaluator 354 may compute a lower trust value for a merchant having little or no historical activity on the e-commerce platform 100, having poor or no billing history on the e-commerce platform 100, or having no subscription or only a trial subscription to the e-commerce platform 100. In another example, using store attributes as trust indicators, the trust evaluator 354 may compute a lower trust value for a store having little or no sales history, having little or no store activity (e.g., no products page), or having little or no fulfillment history. A combination of trust indicators may also be used to compute the trust value.

In some examples, the trust evaluator 354 may also take into account historical trust values computed for the merchant or online store 138 associated with the proposed messaging campaign. The historical trust values may include historical trust values previously computed by the trust evaluator 354 and/or previously provided by an external system (e.g., an external email service) and obtained by the e-commerce platform 100 (e.g., as discussed further below with respect to the rejection tracker 356). The historical trust values may also include trust values that were previously inputted manually (e.g., adjusted by a human support center worker).

In some examples, the trust evaluator 354 may implement a machine-learning based algorithm to compute the trust value. For example, a supervised learning approach may be used to train the trust evaluator 354 to learn a function for inferring the trust value for a proposed messaging campaign, given certain information (e.g., the parameters submitted for the proposed messaging campaign, the user account associated with the proposed messaging campaign, the online store associated with the proposed messaging campaign). A supervised learning approach may use, as training data, historical trust values that have been verified manually, for example.

The trust value computed by the trust evaluator 354 may be a binary value, indicating the proposed messaging campaign is “trustworthy” (and may be conducted according to the campaign parameters) or “untrustworthy” (and should be blocked). The trust value computed by the trust evaluator 354 may alternatively have multiple values or a range of values. For example, the lower the trust value, the lower the trustworthiness of the proposed messaging campaign. A trust value that falls below a defined trust threshold (which may be defined and stored by the trust evaluator 354) may result in the proposed messaging campaign being blocked.

The trust evaluator 354 may compute the trust value based on the proposed messaging campaign itself, based on the merchant associated with the proposed messaging campaign, or based on a combination thereof. For example, the trust evaluator 354 may compute a trust value for the merchant (e.g., based on merchant attributes and/or based on attributes of a store associated with the merchant) and may also compute a trust value for a proposed messaging campaign associated with the merchant. Whether or not a proposed messaging campaign should be blocked may be based on a combination of the trust value for the merchant and the trust value for the proposed messaging campaign. For example, the trust evaluator 354 may implement a 2×2 decision grid that considers both the trustworthiness of the merchant (i.e., trust value of the merchant passes or fails a trust threshold) and the trustworthiness of the proposed messaging campaign (i.e., trust value of the proposed messaging campaign passes or fails another trust threshold).

In some examples, the trust evaluator 354 may perform operations to enable identification of a possible bad actor across multiple user accounts. For example, a bad actor may attempt to outwit the trust assessment by trust evaluator 354, through using multiple user accounts. The trust evaluator 354 may perform operations to catch such attempts, for example by comparing parameters of a proposed messaging campaign with parameters of historical campaigns that were blocked. For example, the trust evaluator 354 may compare lists of recipients and/or message content and/or IP address associated with a proposed messaging campaign with those of historically blocked messaging campaigns. If there is a strong match (e.g., 80% match with 90% confidence or higher), the trust evaluator 354 may also block the proposed messaging campaign.

A challenge with implementation of the trust evaluator 354 is that the assessment of trustworthiness may at times be erroneous or be uncertain. For example, a proposed messaging campaign may be erroneously blocked (which may be considered as a “false positive”) if a merchant has a short history on the e-commerce platform 100, even though the merchant is a legitimate merchant with a fully operating online store 138. Conventionally, a merchant whose proposed messaging campaign has been blocked may be required to contact a support center (or other administrative center) of a messaging service in order to have the messaging campaign unblocked. In some examples, a merchant may not even be notified that their proposed messaging campaign has been blocked. This may be inconvenient and/or aggravating for a legitimate merchant (i.e., not a bad actor). Further, there is conventionally no way for a support worker at the support center to verify whether a merchant who claims to have been erroneously blocked is truly a legitimate merchant or is in fact a bad actor. A support worker may simply rely on trusting the merchant to be honest.

In the example of FIG. 6, the messaging campaign engine 350 includes a rejection tracker 356, which may be implemented as a sub-module of the messaging campaign engine 350 or may be implemented as part of the general functions of the messaging campaign engine 350. The rejection tracker 356 performs operations to enable refinement of the trust assessment algorithm used by the trust evaluator 354 and/or to enable unblocking of an erroneously blocked messaging campaign.

The rejection tracker 356 performs operations to deliberately allow a small quantity (e.g., as a percentage of total blocked emails, or an absolute quantity of blocked emails) of messages from blocked messaging campaigns to actually be sent to selected recipients. The rejection tracker 356 then tracks response to the sent messages, to serve as feedback data. The messages that have been deliberately sent to selected recipients may be referred to as tracked messages. The tracked messages, in the present disclosure, may be tracked in the sense that the e-commerce platform 100 (e.g., using the messaging campaign engine 350) tracks a rejection rate for the tracked messages. The rejection rate may be tracked in the aggregate; it may not be necessary for individual messages to be tracked or identified. The feedback data may be used to refine the trust assessment algorithm used by the trust evaluator 354 (e.g., feedback data may be added to training data for a machine-learning based trust assessment algorithm), and/or may be used as evidence to explain to a merchant why a proposed messaging campaign has been blocked (e.g., when a merchant calls in to the support center).

The rejection tracker 356 may track responses to the tracked messages to determine an overall rejection rate from recipients and/or messaging services. Responses in a variety of formats may be analyzed to determine the rejection rate. Typically, messaging services (e.g., email services) may scan incoming messages to identify possible spam (e.g., based on content, sender address, mass mails, blocked IP address, blocked domains, etc.). The rejection tracker 356 may track deliverability of the tracked messages by inspecting bounce messages or error messages that are generated when a message is rejected by a messaging service. For example, a bounce message or error message may include header information indicating that a message was blocked due to being considered spam. A delivery failure (e.g., indicated by a bounce message, error message or delivery status notification) may be considered a rejection response. For example, recipients and/or external (e.g., third-party) messaging services may reject a tracked message as being possible spam. A negative recipient response, such as, for example, “mark as spam” response or a request to unsubscribe, may also be considered a rejection response.

For a given proposed messaging campaign that has been blocked (e.g., the computed trust value does not meet the trust threshold at the trust evaluator 354), the rejection tracker 356 may permit a small number of tracked messages to be transmitted to selected recipients (e.g., a subset of the intended recipients defined in the parameters for the proposed messaging campaign). The small number of tracked messages may be a small percentage (e.g., 0.2-5%, or 1-2%) of the total number of messages that are intended to be sent from the proposed messaging campaign. In some examples, the rejection tracker 245 may permit a small number of tracked messages to be transmitted to recipients selected from across all blocked messaging campaigns, rather than recipients selected from just one blocked messaging campaign. The rejection tracker 356 may use various techniques for selecting the recipients to whom tracked messages will be sent.

The messaging campaign engine 350 may manage messaging campaigns across a plurality of sender accounts. There may be different sender accounts associated with different blocked messaging campaigns. The rejection tracker 356 may enable tracked messages by selecting recipients across different blocked messaging campaigns associated with different sender accounts.

In one option, the rejection tracker 356 may select a defined small quantity (e.g., a small percentage such as 1% or a small number such as 1000) of blocked messaging campaigns having a trust value just under the trust threshold. For example, among all blocked messaging campaigns, the 1% of blocked campaigns having the highest trust value (i.e., that are considered to be the most trustworthy among the blocked campaigns) may be selected. All of the intended recipients defined for the selected messaging campaigns are then selected as recipients of tracked messages. In other words, the rejection tracker 356 may permit a small number of blocked campaigns to be completely unblocked, and may track the rejection rate for all messages sent from those unblocked campaigns. An advantage of this approach for selecting the recipients of tracked messages is that there may be less bias in how recipients are selected, thus helping to ensure that the rejection rate is sampled across a wide demographic of recipients.

In another option, instead of selecting a small number of blocked messaging campaigns having the highest trust value, the rejection tracker 356 may select a small number of blocked messaging campaigns having a range of trust values. For example, the rejection tracker 356 may randomly select 1% among all blocked messaging campaigns to unblock, and select all intended recipients of those unblocked campaigns to be recipients of tracked messages from those unblocked campaigns. In another example, the rejection tracker 356 may select the small number by proportionally selecting blocked campaigns having different trust values (e.g., selecting equally from: blocked campaigns having the bottom range (e.g., 0-24 percentile) trust value; blocked campaigns having the middle range (e.g., 25-74 percentile) trust value; and blocked campaigns having the top range (e.g., 75-99 percentile) trust value). An advantage of this approach is that there may be less bias in how recipients are selected, and additionally there may be less bias in selecting which campaign to unblock. This may help to ensure that the feedback data that is generated (and which may be used to refine the trust assessment algorithm at the trust evaluator 354) is more robust.

In another option, after selecting certain blocked messaging campaigns to unblock (e.g., using either of the options discussed above), the rejection tracker 356 may select only a subset of the intended recipients as recipients for the tracked messages. That is, for a given one of the unblocked messaging campaigns, a subset of recipients is selected from the intended recipients defined in the campaign parameters of the given unblocked campaign, and tracked messages are transmitted to only the selected subset of recipients. The selected recipients may be a randomly selected small number (e.g., 1% of all intended recipients). In another example, the selected recipients may be selected based on a relationship level (e.g., a strong positive relationship) between the recipients and the sender account (e.g., merchant) or online store associated with the unblocked campaign. A positive relationship level may be established based on, for example, information contained in user profiles of the recipients (e.g., purchase history indicating that the recipient is a past or current customer of the online store; or privacy settings indicating that the recipient has given explicit consent to communications from the online store or merchant). A positive relationship level may also be established based on, for example, information stored by the online store (e.g., a list of recipients who have opted in to receive messages from the store; or a list of recipients who have double opted-in to receive messages from the store). An advantage of this option is that the selected recipients are selected to be those who are more likely to accept messages from the sender account or online store. It may be expected that the rejection rate from these selected recipients would be lower than a more general demographic (who may have little or no established relationship with the sender account or online store). If a selected recipient, who is known to have a positive relationship with the sender account or online store, rejects a message as spam, such a rejection response may be a more definite and reliable indicator that the message truly is spam.

In another option, the rejection tracker 356 may enable transmission of a small amount of tracked messages from all blocked messaging campaigns, regardless of the computed trust value. For example, for every blocked messaging campaign, 1% of intended recipients may be selected (e.g., selected randomly, or selected based on relationship level as discussed above) as recipients of tracked messages. An advantage of this option is that feedback data may be obtained for every blocked campaign, which may be useful to explain to any merchant why their proposed messaging campaign has been blocked.

The rejection tracker 356 may use any suitable technique to select the recipients for receiving tracked messages from an otherwise blocked messaging campaign. Responses to the tracked messages are then tracked by the rejection tracker 356 (e.g., by tracking error messages, or by tracking recipient's “mark as spam” response), to determine an overall rejection rate. The rejection tracker 356 may calculate a rejection metric for the proposed messaging campaign, based on the rejection rate of the tracked messages.

If the rejection metric passes a defined rejection threshold, then the proposed messaging campaign may be unblocked and messages may be transmitted to the remaining intended recipients. The rejection tracker 356 may generate signals to cause the trust evaluator 354 to adjust the trust value for the proposed messaging campaign (and optionally may adjust the trust value for the sender account associated with the proposed messaging campaign). For example, the trust value may be adjusted based on an inverse relationship with the rejection metric (e.g., the lower the rejection metric, the higher the adjusted trust value). In another example, the rejection tracker 356 may generate feedback data that may be added to the training data (e.g., as part of a ground truth dataset) for training a machine-learning based trust assessment algorithm implemented by the trust evaluator 354. If the rejection metric fails the rejection threshold, then the proposed messaging campaign may remain blocked.

The rejection metric generated by the rejection tracker 356 may be stored by the messaging campaign engine 350 in a record, in association with the proposed messaging campaign. The stored rejection metric may be provided in a feedback notification (e.g., in response to a query from the sender account associated with the proposed messaging campaign, or in response to a query from a support worker), for example to support a reason why the proposed messaging campaign was blocked.

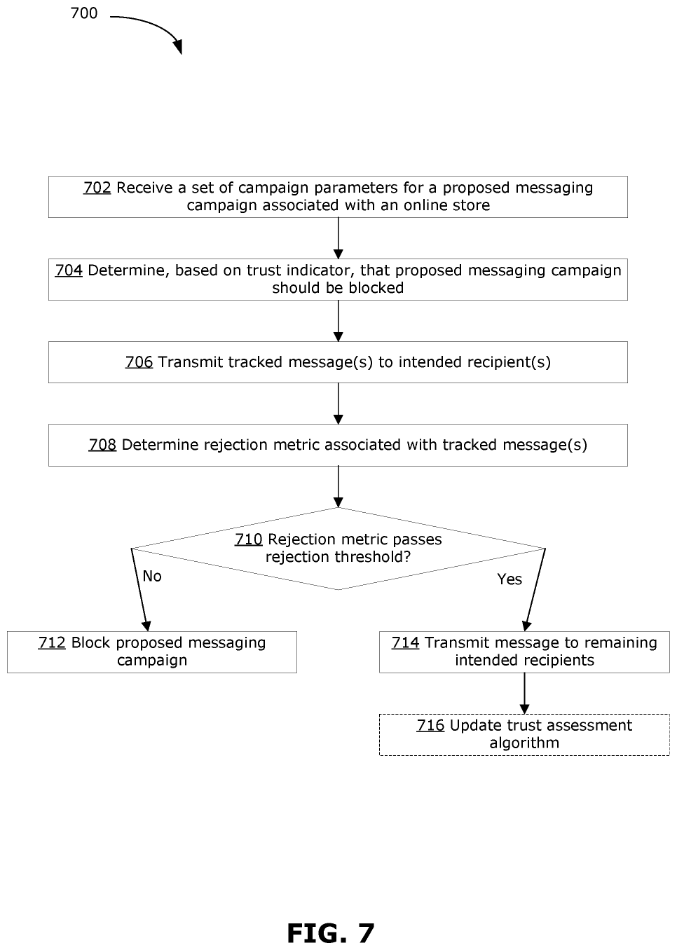

FIG. 7 is a flowchart illustrating an example method 700 for managing messaging campaigns. The method 700 may be implemented by the e-commerce platform 100 (e.g., using the messaging campaign engine 350). The method 700 may be implemented by a processing device executing instructions (e.g., at the core server 510 or the applications server 530).

At 702, a set of parameters for a proposed messaging campaign associated is received, for example from a user account associated with a merchant or marketer via an online user interface provided by the e-commerce platform 100. The proposed messaging campaign may be associated with an online store 138 hosted on the e-commerce platform 100.

In some examples, if the submitted parameters are insufficient to define the proposed messaging campaign (e.g., a required parameter, such as the time duration parameter, has not been defined), the messaging campaign engine 350 may automatically fill in any missing parameters (e.g., using default parameters). Alternatively, the messaging campaign engine 350 may generate a request to the user to provide the missing parameters. The operations to fill in missing parameters, or notify of missing parameters, may be performed by the messaging campaign engine 350 at step 702, or at a later time in the method 700 (e.g., at a later time after the proposed messaging campaign is determined to be from a trustworthy user).

At 704, it is determined, based on a trust indicator, that the proposed messaging campaign should be blocked. For example, the messaging campaign engine 350 (e.g., using the trust evaluator 354) may use a parameter of the proposed messaging campaign, an attribute of the user account associated with the proposed messaging campaign, and/or an attribute of the online store associated with the proposed messaging campaign as the trust indicator. As discussed above, a trust value may be computed using the trust indicator.

When the trust value fails a defined trust threshold (e.g., the trust value has a value that is lower than a defined trust threshold value), the proposed messaging campaign is blocked. Conversely, when the trust value passes the defined trust threshold (e.g., the trust value is at or above the defined trust threshold value), the proposed messaging campaign is allowed and messages are transmitted to the intended recipients in accordance with the parameters of the proposed messaging campaign.

At 706, after determining that a proposed messaging campaign should be blocked, one or more tracked messages are sent, in accordance with the parameters of the proposed messaging campaign, to one or more selected recipients. The selected recipient(s) may be selected from the intended recipients defined by the parameters of the proposed messaging campaign. As discussed above, various techniques may be used to select recipient(s) to whom tracked messages are permitted to be sent. For example, the selected recipient(s) may be selected based on a relationship level between the recipient(s) and the online store associated with the proposed messaging campaign (or associated with the sender account that submitted the proposed messaging campaign).

As previously discussed, the tracked message(s) that are sent may be a permitted subset of messages for the otherwise blocked proposed messaging campaign. For example, tracked message(s) may be sent to only recipient(s) who have a strong positive relationship with the online store or sender account associated with the proposed messaging campaign. In another example, tracked message(s) may be sent to a randomly selected portion (e.g., 1%) of the intended recipient(s). In some examples all of the intended recipients (as defined by the parameters of the proposed messaging campaign) may be selected to receive tracked messages.

At 708, a rejection metric associated with the tracked message(s) is determined. As discussed previously, the rejection metric for the proposed messaging campaign may be determined based on an overall rejection rate (as determined based on rejection responses from recipient(s) and/or messaging service(s), for example) of the tracked message(s). For example, the rejection metric may be calculated as a percentage of responses that are rejected, out of all the tracked messages that were transmitted. In other examples, the rejection metric may be a count of the number of tracked messages that receive a rejection response. Other rejection metrics may be used.

At 710, a determination is made whether the rejection metric passes a predetermined rejection threshold. The rejection threshold may be predetermined based on industry-accepted rejection rates. For example, the rejection threshold may be 0.3%, and a rejection rate of greater than 0.3% may be considered to fail the rejection threshold. In some examples, a rejection threshold that is stricter than industry-accepted rejection rates (e.g., a rejection threshold of 0.1%) may be used. A stricter rejection threshold may be appropriate if the selected recipient(s) of the tracked message(s) are recipient(s) who have a strong positive relationship level with the sender account or online store associated with the proposed messaging campaign. This is because such recipients are expected to be more receptive to messages from that sender account or online store and hence would be expected to have a lower rate of rejection responses.

At 712, if the rejection metric does not pass the rejection threshold (e.g., rejection rate of the tracked message(s) is higher than a defined maximum permissible rejection rate), then the proposed messaging campaign is completely blocked. Optionally, a notification may be generated to the sender account associated with the proposed messaging campaign, to notify that the proposed messaging campaign has been blocked.

At 714, if the rejection metric passes the rejection threshold (e.g., rejection rate of the tracked message(s) is at or below the defined maximum permissible rejection rate), then the proposed messaging campaign is unblocked. Messages may be transmitted to the remainder of the intended recipients, in accordance with the parameters of the proposed messaging campaign. The messages that are transmitted at step 714 may or may not be tracked by the rejection tracker 356.

Optionally, at 716, the trust assessment algorithm that is used by the trust evaluator 354 to compute the trust value may be updated, based on the rejection metric.

The rejection metric determined from the tracked message(s) may optionally be stored, in association with the parameters of the proposed messaging campaign. The stored rejection metric may be used as part of a training dataset for a machine-learning based trust assessment algorithm, for example.

The method 700 may help to improve the experience of a merchant (or marketer) who is using the e-commerce platform 100 to send messages to intended recipients, by enabling automatic unblocking of an erroneously blocked messaging campaign. The merchant (or marketer) may not need to contact a support center or administrator to request unblocking of the campaign. Further, if the campaign was blocked correctly, the rejection metric that is generated may serve as evidence to verify that the campaign was correctly blocked.

Optionally, the rejection metric may be provided as feedback to a merchant (or marketer) to help improve their communication to intended recipients. The feedback provided may be presented as part of a dashboard or administrator homepage, for example. It may be desirable for the feedback to be present in a non-specific way (e.g., only indicating a rejection rate) so that a bad actor would not be able to circumvent the trust assessment algorithm.

The methods and systems described herein may employ a select small number of messages from an otherwise blocked electronic messaging campaign and may deliberately transmit those messages to selected recipients. By tracking rejection responses to these messages, a rejection metric may be determined and used to verify whether the messaging campaign was correctly blocked.

The disclosed methods and systems may provide an automatic way for a blocked sender account or a blocked messaging campaign to become unblocked.

The disclosed methods and systems may be used to help automatically generate a ground truth training dataset, for training machine-learning based trust assessment algorithm. A challenge for developing any machine-learning based algorithm is how to gather a large enough, high quality training dataset. In particular, it is difficult to get information about false positives. Examples described herein enable a dataset of possible false positives to be automatically gathered, without requiring a human to manually review blocked messages for false positives (e.g., legitimate messages that are erroneously blocked).

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

All referenced documents are hereby incorporated by reference in their entireties.

1. A system comprising:
a processing device in communication with a storage, the processing device configured to execute instructions to cause the system to:
receive, from a sender account, a set of parameters for a proposed messaging campaign, the set of parameters including a set of intended recipients;
determine, based on a trust indicator associated with the proposed messaging campaign, that the proposed messaging campaign should be blocked;
select at least one recipient from the set of intended recipients, the at least one recipient being selected based on the at least one recipient having a positive relationship associated with the sender account;
transmit at least one tracked message to the at least one selected recipient from the set of intended recipients, the at least one tracked message being at least a subset of messages for the proposed messaging campaign;
determine a rejection metric associated with the at least one tracked message, wherein determining the rejection metric includes tracking any received messages indicating a rejection response to the at least one tracked message; and
compare the rejection metric to a selected rejection threshold to determine whether the rejection metric is lower than the selected rejection threshold, wherein the selected rejection threshold is a strict rejection threshold that is lower than a standard rejection threshold, and wherein the strict rejection threshold is selected instead of the standard rejection threshold based on the positive relationship between the at least one recipient and the sender account;
wherein the proposed messaging campaign is transmitted to others of the intended recipients responsive to the rejection metric being lower than the strict rejection threshold.

2. The system of claim 1, wherein the processing device is further configured to execute the instructions to cause the system to:
determine, based on the comparison, that the rejection metric is lower than the strict rejection threshold; and
transmit at least one message to at least one remainder recipient from the set of intended recipients responsive to the rejection metric associated with the at least one tracked message being lower than the strict rejection threshold.

3. The system of claim 1, wherein determining the rejection metric includes at least one of:
tracking a received message indicating blocking of the at least one tracked message by an external messaging service;
tracking a received message indicating delivery failure of the at least one tracked message; or
tracking a received message indicating negative recipient response to the at least one tracked message.

4. The system of claim 1, wherein the processing device is further configured to execute the instructions to:
update an algorithm for computing a trust value for the trust indicator, based on the rejection metric.

5. The system of claim 4, wherein the algorithm is learned using a machine-learning sub-system, and wherein updating the algorithm comprises:
including the rejection metric in a training dataset; and
updating the algorithm, using the training dataset to train the machine-learning sub-system.

6. The system of claim 1, wherein the at least one selected recipient is selected based on a relationship level between the at least one selected recipient and the sender account or between the at least one selected recipient and an online store associated with the sender account.

7. The system of claim 1, wherein determining, based on the trust indicator associated with the proposed messaging campaign, that the proposed messaging campaign should be blocked includes:
computing a trust value for the trust indicator based on the set of parameters; and
determining that the proposed messaging campaign should be blocked responsive to the trust value failing a trust threshold.

8. (canceled)

9. The system of claim 1, wherein the processing device is further configured to execute the instructions to:
manage a plurality of proposed messaging campaigns;
wherein tracked messages are transmitted to selected recipients across the plurality of proposed messaging campaigns, the tracked messages totaling a defined quantity.

10. A method for managing messaging campaigns, the method comprising:
receiving, from a sender account, a set of parameters for a proposed messaging campaign, the set of parameters including a set of intended recipients;
determining, based on a trust indicator associated with the proposed messaging campaign, that the proposed messaging campaign should be blocked;
select at least one recipient from the set of intended recipients, the at least one recipient being selected based on the at least one recipient having a positive relationship associated with the sender account;
transmitting at least one tracked message to the at least one selected recipient from the set of intended recipients, the at least one tracked message being at least a subset of messages for the proposed messaging campaign;
determining a rejection metric associated with the at least one tracked message, wherein determining the rejection metric includes tracking any received messages indicating a rejection response to the at least one tracked message; and
comparing the rejection metric to a selected rejection threshold to determine whether the rejection metric is lower than the selected rejection threshold wherein the selected rejection threshold is a strict rejection threshold that is lower than a standard rejection threshold, and wherein the strict rejection threshold is selected instead of the standard rejection threshold based on the positive relationship between the at least one recipient and the sender account;
wherein the proposed messaging campaign is transmitted to others of the intended recipients responsive to the rejection metric being lower than the strict rejection threshold.

11. The method of claim 10, further comprising:
determining, based on the comparison, that the rejection metric is lower than the strict rejection threshold; and
transmitting at least one message to at least one remainder recipient from the set of intended recipients responsive to the rejection metric associated with the at least one tracked message being lower than the strict rejection threshold.

12. The method of claim 10, wherein determining that the rejection metric passes the rejection threshold comprises:
tracking a received message indicating blocking of the at least one tracked message by an external messaging service;
tracking a received message indicating delivery failure of the at least one tracked message; or
tracking a received message indicating negative recipient response to the at least one tracked message.

13. The method of claim 10, further comprising:
updating an algorithm for computing a trust value for the trust indicator, based on the rejection metric.

14. The method of claim 13, wherein the algorithm is learned using a machine-learning sub-system, and wherein updating the algorithm comprises:
including the rejection metric in a training dataset; and
updating the algorithm, using the training dataset to train the machine-learning sub-system.

15. The method of claim 10, wherein the at least one selected recipient is selected based on a relationship level between the at least one selected recipient and the sender account or between the at least one selected recipient and an online store associated with the sender account.

16. The method of claim 10, wherein determining, based on the trust indicator associated with the proposed messaging campaign, that the proposed messaging campaign should be blocked comprises:
computing a trust value for the trust indicator based on the set of parameters; and
determining that the proposed messaging campaign should be blocked responsive to the trust value failing a trust threshold.

17. (canceled)

18. The method of claim 10, further comprising:
managing a plurality of proposed messaging campaigns;
wherein tracked messages are transmitted to selected recipients across the plurality of proposed messaging campaigns, the tracked messages totaling a defined quantity.

19. A computer-readable medium having computer-executable instructions stored thereon, wherein the instructions, when executed by a processing device of a system, cause the system to:
receive, from a sender account, a set of parameters for a proposed messaging campaign, the set of parameters including a set of intended recipients;
determine, based on a trust indicator associated with the proposed messaging campaign, that the proposed messaging campaign should be blocked;
select at least one recipient from the set of intended recipients, the at least one recipient being selected based on the at least one recipient having a positive relationship associated with the sender account;
transmit at least one tracked message to at least one selected recipient from the set of intended recipients, the at least one tracked message being at least a subset of messages for the proposed messaging campaign;
determine a rejection metric associated with the at least one tracked message, wherein determining the rejection metric includes tracking any received messages indicating a rejection response to the at least one tracked message; and
compare the rejection metric to a selected rejection threshold to determine whether the rejection metric is lower than the selected rejection threshold, wherein the selected rejection threshold is a strict rejection threshold that is lower than a standard rejection threshold, and wherein the strict rejection threshold is selected instead of the standard rejection threshold based on the positive relationship between the at least one recipient and the sender account;
wherein the proposed messaging campaign will be transmitted to others of the intended recipients responsive to the rejection metric being lower than the strict rejection threshold.

20. The computer-readable medium of claim 19, wherein the instructions further cause the system to:
determine, based on the comparison, that the rejection metric is lower than the strict rejection threshold; and
transmit at least one message to at least one remainder recipient from the set of intended recipients responsive to the rejection metric associated with the at least one tracked message being lower than the strict rejection threshold.

21. The computer-readable medium of claim 19, wherein determining the rejection metric includes at least one of:
tracking a received message indicating blocking of the at least one tracked message by an external messaging service;
tracking a received message indicating delivery failure of the at least one tracked message; or
tracking a received message indicating negative recipient response to the at least one tracked message.

22. The computer-readable medium of claim 19, wherein the at least one selected recipient is selected based on a relationship level between the at least one selected recipient and the sender account or between the at least one selected recipient and an online store associated with the sender account.
